(19) United States
(12) Patent Application Publication
(10) Pub. No.: US 2013/0260264 A1
(43) Pub. Date: Oct. 3, 2013

(54) AIR BATTERY AND ELECTRONIC DEVICE

(71) Applicant: SONY CORPORATION, Tokyo (JP)

(72) Inventors: Keisuke Shimizu, Kanagawa (JP); Eishi Endo, Tokyo (JP)

(73) Assignee: Sony Corporation, Tokyo (JP)

(21) Appl. No.: 13/850,722

(22) Filed: Mar. 26, 2013

(30) Foreign Application Priority Data
Apr. 2, 2012 (JP) 2012-083480

(51) Int. Cl. H01M 12/08; H01M 12/00

(52) U.S. Cl. CPC H01M 12/08; H01M 12/00
USPC 429/405; 29/623.1

(57) ABSTRACT

A battery device, including a negative electrode; an air electrode; and an electrolyte layer that is provided between the negative electrode and the air electrode, where the air electrode includes a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions

### BACKGROUND

In air batteries (also referred to as metal-air batteries), a metal having high energy density can be used as a negative electrode active material, and oxygen in the air is used as a positive electrode active material.

Thus, air batteries may operate as a half battery, and the amount of electrode active material may be reduced or halved. Accordingly, air batteries may theoretically obtain an improved energy density. The electromotive force and capacity of air batteries differ greatly depending on the kind of metal used for the negative electrode. For example, research has been conducted into practical applications of air batteries in which lithium (i.e., a metal with the smallest atomic number) is used for a negative electrode because a large capacity may be obtained, as well as improved theoretical electromotive force as large as about 3 V.

An air battery may include an air electrode (positive electrode), a negative electrode, an electrolyte layer, and a housing provided with an opening through which oxygen is taken in from the outside, for example. In various aspects, the air electrode is formed from a carbon material and a catalyst, such as a metal, that is added to the carbon material, in a reaction field of oxygen. As described above, the negative electrode may be formed from a metal element such as lithium. An electrolytic solution that is used for the electrolyte layer is broadly classified into an organic electrolytic solution and an aqueous electrolytic solution. Various electrolytic solutions have advantages and disadvantages. However, an organic electrolytic solution has the advantage that the theoretical capacity is larger than that of an aqueous electrolytic solution. In addition, the electrolyte layer may be formed from a separator impregnated with the electrolytic solution to prevent a short between the air electrode and the negative electrode.

### SUMMARY

However, air batteries are problematic in that, during discharging, an insulating discharge product (e.g., reaction product such as Li₂O₂ or Li₂O, among others) is generated from a side that is close to an oxygen introducing portion in the air electrode of the battery. When a surface of the air electrode is covered with the discharge product, it clogs a void that otherwise allows passage of oxygen in the air electrode. Thus, oxygen diffusion to the inside of the air electrode is suppressed from an initial discharging stage, and the discharging is inhibited and/or terminated. In other words, the discharge capacity of the air battery is reduced or eliminated. As the thickness of the air electrode increases, this problem also increases.

Therefore, it is desirable to provide an air battery that is capable of substantially maintaining oxygen diffusion to the inside of an air electrode over time during discharging, and is also capable of obtaining an improved discharge capacity. Furthermore, it is desirable to provide an air battery adapted for use with an electronic device.

The above-described objects and other objects will be apparent from the description of the following specification with reference to the attached drawings.

In various aspects of the present disclosure, there is provided a battery device, including: a negative electrode; an air electrode; and an electrolyte layer that is provided between the negative electrode and the air electrode, where the air electrode includes a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions.

In addition, according to other aspects of the present disclosure, there is provided an electronic device including: an air battery, where the air battery includes a negative electrode; an air electrode; and an electrolyte layer that is provided between the negative electrode and the air electrode, where the air electrode comprises a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions.

In various aspects of the present disclosure, the discharge over-voltage represents a magnitude of deviation of a discharge voltage during discharging of a battery from an equilibrium potential. In addition, under similar conditions, the smaller the magnitude of deviation is, the higher the discharge potential becomes. In certain embodiments, the air electrode may include a plurality of portions in which discharge over-voltages are different from each other, and the discharge over-voltage may increase in a stepwise fashion or substantially continuously in a direction from the negative electrode to the air electrode. For example, catalysts that have discharge over-voltages different from each other may be present in the plurality of portions of the air electrode. The discharge over-voltage of these catalysts may increase in a stepwise fashion or substantially continuously in a direction from the negative electrode to the air electrode. These catalysts may be catalysts that are known in the art. In various aspects, the air electrode may include a first portion positioned on the negative electrode side and a second portion positioned on a side that is opposite to the negative electrode, a first catalyst having a first discharge over-voltage may be present at the first portion, and a second catalyst having a second discharge over-voltage higher than the first discharge over-voltage may be present at the second portion. The catalysts described herein may be said to be “positioned on” or “positioned in” and these terms include various arrangements of the catalysts; for example, the catalysts may be within a component, or on a component, or distributed throughout or around components of the battery in various manners.

In other aspects, in the air electrode, a first catalyst having a first discharge over-voltage may be present in a concentration distribution that decreases in a direction from the negative electrode to the air electrode, and a second catalyst having a second discharge over-voltage higher than the first discharge over-voltage may be present in a concentration distribution that increases in a direction from the negative electrode to the air electrode. The increases and decreases in concentrations and/or discharge over-voltage described herein may be substantially continuous or not. In these examples, the second discharge over-voltage may be higher than the first discharge over-voltage by 0.01 V or more, or by more preferably 0.1 V or more. In other examples, the air electrode may include a first portion positioned on the negative electrode side and a second portion positioned on a side that is opposite to the negative electrode, a catalyst may be present at the first portion, the catalyst may be not present at the second portion, and the discharge over-voltage of the second portion may be higher than the discharge over-voltage of the catalyst.

In still other examples, in the air electrode, a catalyst may be present in a concentration distribution that decreases in a direction from the negative electrode to the air electrode. On the other hand, in the air battery, a charge over-voltage of a portion of the air electrode on a negative electrode side may have approximately similar to or higher charge over-voltage than a charge over-voltage of other portions to assist in preventing oxygen from being retained inside the air electrode during charging. For example catalysts are used where a charge over-voltage of a second catalyst is lower than that of a first catalyst.

In addition, according to other aspects of the present disclosure, there is provided an air battery adapted for use with a battery pack, where the air battery includes a control unit that performs a control with respect to the air battery; a housing in which the air battery is accommodated, where the air battery includes a negative electrode; an air electrode; and an electrolyte layer that is provided between the negative electrode and the air electrode, where the air electrode comprises a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions.

In exemplary battery packs, the control unit may perform control of charging, discharging, over-discharging, or over-charging with respect to the air battery.

In addition, according to yet other aspects of the present disclosure, there is provided an air battery adapted for use with an electronic device, where the air battery includes a control unit that performs a control with respect to the air battery; a housing in which the air battery is accommodated, where the air battery includes a negative electrode; an air electrode; and an electrolyte layer that is provided between the negative electrode and the air electrode, where the air electrode comprises a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions, and where electric power is supplied from the air battery.

The electronic device may be any electronic device and may be a portable type device, a stationary type device, or any combination of both. Examples of the electronic device include cellular phones, mobile devices, robots, computers including personal computers, vehicular devices including in-vehicle devices, appliances including various household electric appliances, and others.

In addition, according to still other aspects of the disclosure, an air battery may be adapted for use with an electrically driven vehicle, where the vehicle includes a converter to which electric power is supplied from an air battery and which converts the electric power to a driving force of the vehicle; and a control device that processes information regarding vehicle control on the basis of information related to the air battery, and where the air battery includes a negative electrode; an air electrode; and an electrolyte layer that is provided between the negative electrode and the air electrode, where the air electrode comprises a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions.

In at least one aspect, in an electrically driven vehicle, the convertor may be supplied with electric power from the air battery and can rotate a motor to generate a driving force. The motor may use regenerative energy. In addition, the control device may perform, for example, information processing related to a vehicle control on the basis of remaining battery power of the air battery. This electrically driven vehicle can include, a hybrid car, an electric vehicle, an electric bike, an electric bicycle, and a railway vehicle, among others.

In addition, according to further aspects of the present disclosure, there is provided an air battery adapted for use with an electric power system that may be constructed to be supplied with electric power from the air battery and/or to supply the electric power to the air battery from an electric power source, where the air battery includes a negative electrode; an air electrode; and an electrolyte layer that is provided between the negative electrode and the air electrode, where the air electrode comprises a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions.

Electric power systems may include, for example, a smart grid, a household energy management system (HEMS), and a vehicle, among others, and may store electricity.

In addition, according to other aspects of the present disclosure, there is provided an air battery adapted for use with an electric-power-storage power supply. The electric-power-storage power supply may be constructed in such a manner that it is connected to an electronic device to which electric power is supplied, and the air battery includes a negative electrode; an air electrode; and an electrolyte layer that is provided between the negative electrode and the air electrode, where the air electrode comprises a plurality of portions having discharge over-voltages that are different between each portion in a direction from the negative electrode to the air electrode, and where a discharge over-voltage of a portion of the air electrode closest to the negative electrode is lower than a discharge over-voltage of the other of the plurality of portions.

Further, the electric-power-storage power supply may be used in any electric power system or any electric power device regardless of its use, and for example, may also be used in a smart grid.

In the air battery described herein, from the viewpoint of improving the reliability of obtaining an effect of generating a discharge product from a portion of the air electrode on a negative electrode side during discharging, a current collector connected to the air electrode may be constructed. For example, a first current collector, which is electrically connected to the air electrode, may be provided positioned on a surface of the air electrode on a negative electrode side, and a second current collector, which is electrically connected to the air electrode, may be provided positioned on at least one of on a surface of the air electrode on a side that is opposite to the negative electrode and may be inside of the air electrode. In addition, during discharging of the air battery, a voltage, which is positive with respect to a negative electrode, may be applied to at least the first current collector in the first current collector. Alternatively, or in addition to, applying the voltage to the first current collector, the voltage may be applied to the second current collector. In addition, during charging of the air battery, a voltage, which is positive with respect to a negative electrode, may be applied to at least the second current collector. Alternatively, or in addition to, applying the voltage to the second current collector, the voltage may be applied to the first current collector. In various aspects, the second current collector may have an oxygen-permeable configuration. For example, the second current collector may have openings through which oxygen passes. These first and second current correctors may be formed from a metallic mesh (e.g., a metal having a net structure).

According to the present disclosure, during discharging, it may be advantageously possible to allow a discharge product to be generated from a portion of the air electrode on a negative electrode side at which a discharge over-voltage is lower or lowest. Accordingly, it is advantageously possible to effectively prevent a surface of the air electrode from being covered with the discharge product, and thereby prevent a void from being clogged by the discharge product, which would block or inhibit the flow of oxygen in, to or from the air electrode. As a result, diffusion of oxygen to the inside of the air electrode may advantageously be substantially maintained for a longer time. In addition, in a case where a charge over-voltage of a portion of the air electrode on a negative electrode side may be approximately similar to, or higher than, a charge over-voltage of other portions during charging, it may advantageously be possible to decompose the discharge product from a portion of the air electrode on a side that is opposite to the negative electrode. Thus, in various aspects of the present disclosure, oxygen that is generated by the decomposition of the discharge product may be smoothly emitted to the outside from an oxygen intake surface of the air electrode after passing through the inside of the air electrode. Thereby the oxygen may advantageously be effectively prevented from being retained inside the air electrode.

According to other aspects of the present disclosure, it may be possible to obtain an air battery that is capable of substantially maintaining oxygen diffusion to the inside of an air electrode for a long time during discharging and is capable of obtaining a high discharge capacity. In addition, when a charge over-voltage of a portion of the air battery on a negative electrode side is approximately similar to or higher than a charge over-voltage of other portions, oxygen may be advantageously prevented from being retained inside the air electrode during charging. In addition, the air batteries disclosed herein may be adapted for use with a battery pack, an electronic device, an electrically driven vehicle, an electric power system, and an electric-power-storage power supply, among others, with improved performance of these devices and/or systems.

### BRIEF DESCRIPTION OF THE DRAWINGS

FIG. 1 is a diagram illustrating an air battery according to certain embodiments;

FIG. 2 is a diagram illustrating an air electrode of the air battery according to certain embodiments;

FIG. 3 is a diagram illustrating a structural example of the air battery according to certain embodiments;

FIG. 4 is a view illustrating the air battery as shown in FIG. 3;

FIG. 5 is a diagram illustrating a structural example of the air battery according to certain embodiments;

FIG. 6 is a diagram illustrating a structural example according to certain embodiments;

FIG. 7 is a diagram illustrating an operation of the air battery according to certain embodiments;

FIGS. 8A and 8B are diagrams illustrating an air electrode of an air battery and a catalyst concentration distribution in an air electrode, according to certain embodiments;

FIG. 9 is a diagram illustrating an air electrode of an air battery according to certain embodiments;

FIGS. 10A and 10B are cross-sectional diagrams illustrating an air electrode of an air battery and a catalyst concentration distribution in an air electrode, according to certain embodiments;

FIG. 11 is a diagram illustrating an air battery according to certain embodiments;

FIG. 12 is a diagram illustrating a structural example of an air battery according to certain embodiments;

FIG. 13 is a view of the air battery shown in FIG. 12;

FIG. 14 is a diagram illustrating a structural example of an air battery according to certain embodiments;

FIG. 15 is a diagram illustrating an air electrode that is used in an air battery according to certain embodiments;

FIG. 16 is a diagram illustrating an operation of an air battery according to certain embodiments;

FIG. 17 is a diagram illustrating an air battery, according to certain embodiments;

FIG. 18 is a view illustrating an air battery, according to certain embodiments;

FIG. 19 is a diagram illustrating an air battery according certain embodiments;

FIG. 20 is a diagram illustrating an air battery according to certain embodiments;

FIG. 21 is a diagram illustrating a battery pack according to certain embodiments;

FIG. 22 is a diagram illustrating a vehicle according to certain embodiments; and

FIG. 23 is a diagram illustrating a power system according to certain embodiments.

### DETAILED DESCRIPTION

The present disclosure contains subject matter related to that disclosed in Japanese Priority Patent Application JP 2012-083480 filed in the Japan Patent Office on Apr. 2, 2012, the entire contents of which are hereby incorporated by reference.

Hereinafter, certain embodiments of the present disclosure (hereinafter, referred to as “embodiments”) are described. Although reference is made to various numbers of certain embodiments, the references to the numbers of embodiments are non-limiting. Thus, the present disclosure contains detailed description of exemplary embodiments to provide an understanding of the present disclosure. The description is made as follows:

1. First Embodiment (Air Battery, Manufacturing Method thereof, and Using Method thereof)

2. Second Embodiment (Air Battery, Manufacturing Method thereof, and Using Method thereof)

3. Third Embodiment (Air Battery, Manufacturing Method thereof, and Using Method thereof)

4. Fourth Embodiment (Air Battery, Manufacturing Method thereof, and Using Method thereof)

5. Fifth Embodiment (Air Battery, Manufacturing Method thereof, and Using Method thereof)

6. Sixth Embodiment (Air Battery, Manufacturing Method thereof, and Using Method thereof)

7. Seventh Embodiment (Air Battery, Manufacturing Method thereof, and Using Method thereof)

### 1. First Embodiment

Air Battery

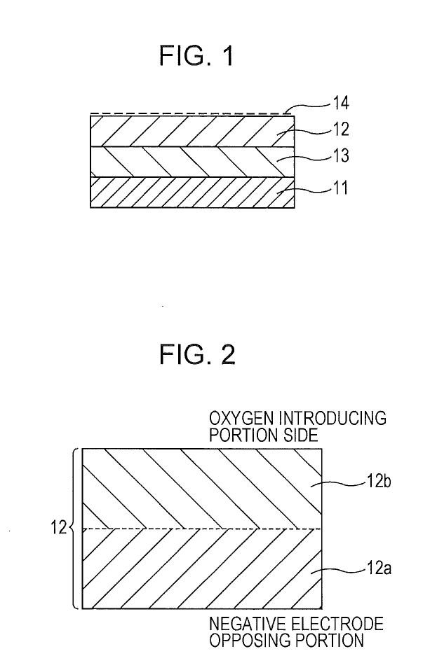

FIG. 1 shows an air battery according to the first embodiment. As shown in FIG. 1, the air battery includes a negative electrode 11, an air electrode 12, and an electrolyte layer 13 that is positioned between the negative electrode 11 and the air electrode 12. The air battery further includes a current collector 14 that is positioned on a surface of the air electrode 12 on a side that is opposite to the negative electrode 11 and is electrically connected to the air electrode 12.

The negative electrode 11 is constructed using a material containing at least one kind of metal, and may be a material containing at least one kind of metal as a main component. Examples include elemental metal including one or more selected from lithium (Li), potassium (K), sodium (Na), magnesium (Mg), calcium (Ca), zinc (Zn), and aluminum (Al), among others; an alloy formed from two or more kinds of metals among these metals; and an alloy of one of these metals and another metal (for example, an alloy of Li and Si (silicon), and an alloy of Li and Sn (tin), among others)e, with no limitation thereto. In addition, the negative electrode 11 may contain another conductive material, binding material, or other materials. This conductive material may be either an organic material or an inorganic material. Examples of the organic material include conductive polymers, and other organic materials. Examples of the inorganic material include carbon-based materials (for example, various carbon particles), and other inorganic materials. Binding materials, such as polyvinylidene fluoride (PVDF), styrene butadiene rubber (SBR), and polytetrafluoroethylene (PTFE), among others, may be used. Although the content of this conductive material or binding material that is contained in the negative electrode 11 is not limited, the content may be as small as possible to the extent that conductivity of the negative electrode 11 may be obtained and a shape may be stably maintained.

The air electrode 12 may be formed from a conductive material, a catalyst material, and/or a binding material, among others. The conductive material is not limited and the conductive material has conductivity and may be resistant to usage conditions of the air battery. For example, a carbon material such as carbon black, activated carbon, and carbon fibers may be used as a conductive material. Because a discharge product is generated on a surface of the conductive material during discharging of the air battery, the conductive material may have an increased specific surface area. In addition, the content of the conductive material in the air electrode 12 may be increased from the viewpoint of a battery capacity. A binding material such as PVDF, SBR, and PTFE, among others, may be used. The content of the binding material is not limited, and may be decreased such that a shape of the electrode may be stably maintained.

For example, as shown in FIG. 2, a first catalyst having a first discharge over-voltage is present at a lower portion 12a of the air electrode 12 on a negative electrode 11 side, and a second catalyst having a second discharge over-voltage higher than the first discharge over-voltage is present on an upper portion 12b of the air electrode 12 on a side that is opposite to the negative electrode 11. Catalysts in which a charge over-voltage of a first catalyst is similar to or higher than that of a second catalyst may be used.

Examples of materials of the first catalyst and the second catalyst that may be used include various kinds of inorganic ceramics, such as manganese dioxide (MnO₂) (electrolysis manganese dioxide (EMD), among others), tricobalt tetroxide (Co₂O₄), nickel oxide (NiO), iron (III) oxide (Fe₂O₂), ruthenium (IV) oxide (RuO₂), copper (II) oxide (CuO), vanadium pentoxide (V₂O₅), molybdenum (VI) oxide (MoO₂), yttrium (III) oxide (Y₂O₂), and iridium (IV) oxide (IrO₂), various kinds of metals such as gold (Au), platinum (Pt), palladium (Pd), ruthenium (Ru), and various kinds of organic metal complex such as cobalt phthalocyanine, and other catalytic materials. For example, two kinds of materials in which discharge over-voltages are different from each other may be used as materials of the first catalyst and the second catalyst. These materials may be selected in such a manner that the second discharge over-voltage is higher than the first discharge over-voltage by 0.01 V or more, or by more preferably 0.1 V or more. As an example, when Ru and Au, in which discharge over-voltages under similar discharge conditions are different from each other by approximately 0.1 V, are used as the first catalyst and the second catalyst, respectively, improved characteristics may be realized. A catalyst amount is not limited, and the catalyst amount may be decreased to the extent that a sufficient catalyst function may be exhibited with this amount.

For example, the electrolyte layer 13 includes an electrolytic solution that carries out conduction of metal ions between the negative electrode 11 and the air electrode 12, and a separator that is filled with the electrolytic solution. The electrolytic solution is not limited and may be selected from various electrolytic solutions to the extent that the electrolytic solutions have metal ion conductivity. In certain embodiments, an electrolytic solution in which a metal salt is dissolved in an organic solvent may be used. For example, in an air battery in which Li is used for the negative electrode 11, LiPF₆, LiClO₄, LiBF₄, LiCF₃SO₃, LiN(CF₃SO₂)₂, LiN(C₂F₅SO₂)₂, LiC(CF₃SO₂)₃, or other Li compounds may be used as the lithium salt. In addition, an organic solvent may be used. Various examples of the organic solvent that may be used, including propylene carbonate, ethylene carbonate, dimethyl carbonate, diethyl carbonate, γ-butyrolactone, 1,2-dimethoxyethane, diethylene glycol dimethyl ether, triethylene glycol dimethyl ether, tetraethylene glycol dimethyl ether, tetrahydrofuran, acetonitrile, dimethyl sulfoxide, siloxane, an ion liquid, and a compound thereof, among others. As an example, a concentration of a salt in the electrolytic solution may be approximately 0.1 to 2 mol/L. As the separator that is used for the electrolyte layer 13, for example, a porous membrane of polyethylene, polypropylene, or other separator materials, a non-woven fabric such as a glass fiber, or others, may used.

The electrolyte layer 13 may be a polymer electrolyte in which an electrolyte is added to polyethylene oxide or other components, or a gel electrolyte in which an electrolytic solution is supported by PVDF or other components. In addition, in a case where a negative electrode active material is lithium, for example, the electrolyte layer 13 may be a solid electrolyte such as lithium ion conductive glass ceramic. In addition, the electrolyte layer 13 may contain a liquid, a polymer, and a solid electrolyte, respectively, or these may be formed in a layer state. For example, the electrolyte layer 13 may have a three-layer structure of a polymer electrolyte/a solid electrolyte/a liquid-based electrolyte from the negative electrode 11 side.

The current collector 14 allows electrons to enter the air electrode 12 and exit therefrom during charging and discharging of the air battery. The current collector 14 is constructed to have permeability with respect to oxygen in order for oxygen to be supplied to the air electrode 12 through the current collector 14. In certain embodiments, the current collector 14 is constructed by a metallic mesh. Although the material mesh's material is not limited, the material may be resistant to usage conditions of the air battery, and a metallic mesh formed from Ni (nickel) or stainless steel (SUS) may be used. Hole diameters of the metallic mesh are not limited, and may include various diameters.

Structural Example of an Air Battery

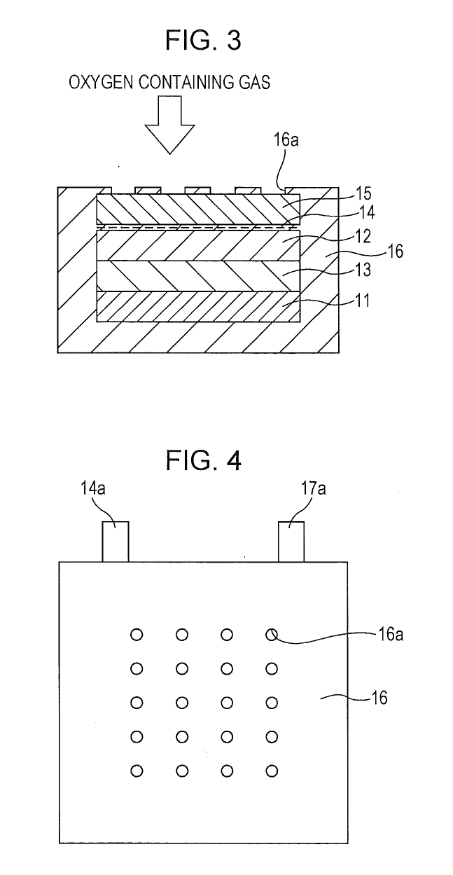

FIG. 3 shows a structural example of the air battery. As shown in FIG. 3, in the air battery, an oxygen-permeable membrane 15 is provided on the current collector 14 formed on the air electrode 12. In addition, all of the negative electrode 11, the electrolyte layer 13, the air electrode 12, the current collector 14, and the oxygen-permeable membrane 15 are accommodated inside a housing 16. Openings 16a are formed in an upper portion of the housing 16, which comes into contact with the oxygen-permeable membrane 15, and the air (for example, an oxygen-containing gas) reaches the oxygen-permeable membrane 15 from the outside through the openings 16a. In addition, after reaching the oxygen-permeable membrane 15, the air permeates through the oxygen-permeable membrane 15, and is supplied to the air electrode 12.

FIG. 4 shows an example of a view of the air battery shown in FIG. 3. As shown in FIG. 4, in this example, the air battery has a rectangular or square planar shape, and overall, the air battery has a quadrangular prism shape. The openings 16a are formed in the upper portion of the housing 16, which comes into contact with the oxygen-permeable membrane 15, in a two-dimensional matrix form. A lead portion 14a leads out from the current collector 14 to the outside of the battery. Furthermore, although not shown in FIG. 3, a lead portion 17a also leads out to the outside of the battery from a current collector that is provided on a lower surface of the negative electrode 11 to be electrically connected to this negative electrode 11. In this example, the lead portions 14a and 17a lead out from only one side surface of the air battery, but there is no limitation thereto.

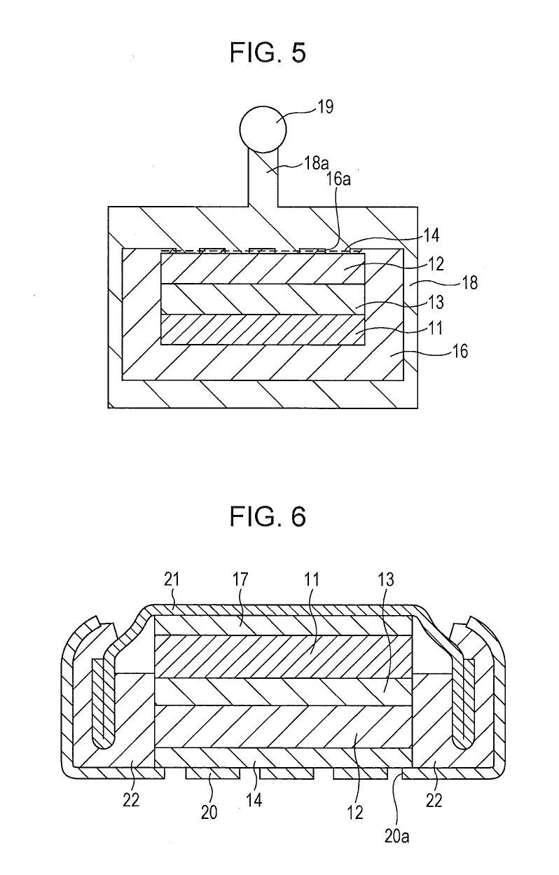

FIG. 5 shows another structural example of the air battery. As shown in FIG. 5, in this air battery, the oxygen-permeable membrane 15 is not provided differently from the air battery shown in FIG. 3. In addition, all of the negative electrode 11, the electrolyte layer 13, the air electrode 12, and the current collector 14 are accommodated inside the housing 16. This housing 16 is accommodated inside a relatively large housing 18. This housing 18 has airtightness except for one end 18a, and the one end 18a is connected to a gas acquisition port of an oxygen bomb 19. In addition, oxygen may be supplied to the inside of the housing 18 in accordance with opening and closing of the oxygen bomb 19. The openings 16a are formed in an upper portion of the housing 16, which comes into contact with the air electrode 12, and oxygen, which is supplied to the inside of the housing 18, is supplied to the air electrode 12 through the openings 16a.

FIG. 6 shows still another structural example of the air battery, and shows a button-type air battery. As shown in FIG. 6, in the button-type air battery, the current collector 14, the air electrode 12, the electrolyte layer 13, the negative electrode 11, and a current collector 17, each having a circular shape, are sequentially laminated, and overall, these have a columnar shape. These columnar current collector 14, air electrode 12, electrolyte layer 13, negative electrode 11, and current collector 17 are interposed between an exterior casing 20 and an exterior cup 21, and a peripheral portion of the exterior cup 21 is caulked and hermetically sealed to a peripheral portion of the exterior casing 20 through a gasket 22. Openings 20a are formed in portion of the exterior casing 20, which comes into contact with the current collector 14.

Method of Manufacturing an Air Battery

A method of manufacturing the air battery will be described.

The negative electrode 11 is formed and the current collector 14 is formed on an upper surface of the air electrode 12. For example, the air electrode 12 may be formed as described below. For example, a first electrode material containing a first catalyst and a second electrode material containing a second catalyst are mixed into a predetermined organic solvent in a predetermined ratio, respectively, and the organic solvent is sufficiently evaporated from the first electrode material and the second electrode material, respectively. The second electrode material is press-molded on the current collector 14 constructed by, for example, a metallic mesh, and the first electrode material is placed on the second electrode material, and the press-molding is again performed. In this manner, the air electrode 12, in which the first catalyst having a first discharge over-voltage is present in the lower portion 12a and the second catalyst having a second discharge over-voltage higher than the first discharge over-voltage is present in the upper portion 12b, is formed.

The air electrode 12 may also be formed by the following method. For example, the second electrode material containing the organic solvent is applied on the current collector 14 constructed by, for example, a metallic mesh, and the applied second electrode material is dried to evaporate the organic solvent. The first electrode material containing the organic solvent is applied on the second electrode material, and the first electrode material is dried to evaporate the organic solvent. In this manner, the air electrode 12, in which the first catalyst having a first discharge over-voltage is present in the lower portion 12a and the second catalyst having a second discharge over-voltage higher than the first discharge over-voltage is present in the upper portion 12b, is formed.

The negative electrode 11 and the air electrode 12 are made to face each other through the electrolyte layer 13. In certain embodiments, as shown in FIG. 1, a target air battery is manufactured.

In a case of using the oxygen-permeable membrane 15 similarly to the air battery shown in FIG. 3, the oxygen-permeable membrane 15 is provided on the air electrode 12 through the current collector 14. In addition, as shown in FIG. 3, all of the negative electrode 11, the electrolyte layer 13, the air electrode 12, the current collector 14, and the oxygen-permeable membrane 15 are accommodated inside the housing 16.

In addition, in the air battery as shown in FIG. 5, the housing 16 is accommodated inside the housing 18, and one end 18a of the housing 18 is connected to a gas acquisition port of the oxygen bomb 19.

In addition, in the air battery as shown in FIG. 6, the columnar current collector 14, air electrode 12, electrolyte layer 13, negative electrode 11, and current collector 17 are accommodated in the exterior casing 20, and the gasket 22 is provided at the periphery of the columnar current collector 14, air electrode 12, electrolyte layer 13, negative electrode 11, and current collector 17. The columnar current collector 14, air electrode 12, electrolyte layer 13, negative electrode 11, and current collector 17 are covered with the exterior cup 21, and the peripheral portion of the exterior cup 21 is caulked and hermetically sealed.

Method of Using an Air Battery

In the air battery, during discharging, a voltage, which is positive with respect to the negative electrode 11, is applied to the current collector 14. At this time, metal ions (for example, lithium ions (Li⁺)) migrate from the negative electrode 11 to the air electrode 12 through the electrolyte layer 13, whereby electric energy is generated. On the other hand, during charging, a voltage, which is positive with respect to the negative electrode 11, is applied to the current collector 14. At this time, the metal ions migrate from the air electrode 12 to the negative electrode 11 through the electrolyte layer 13, whereby the electric energy is converted into chemical energy and is stored.

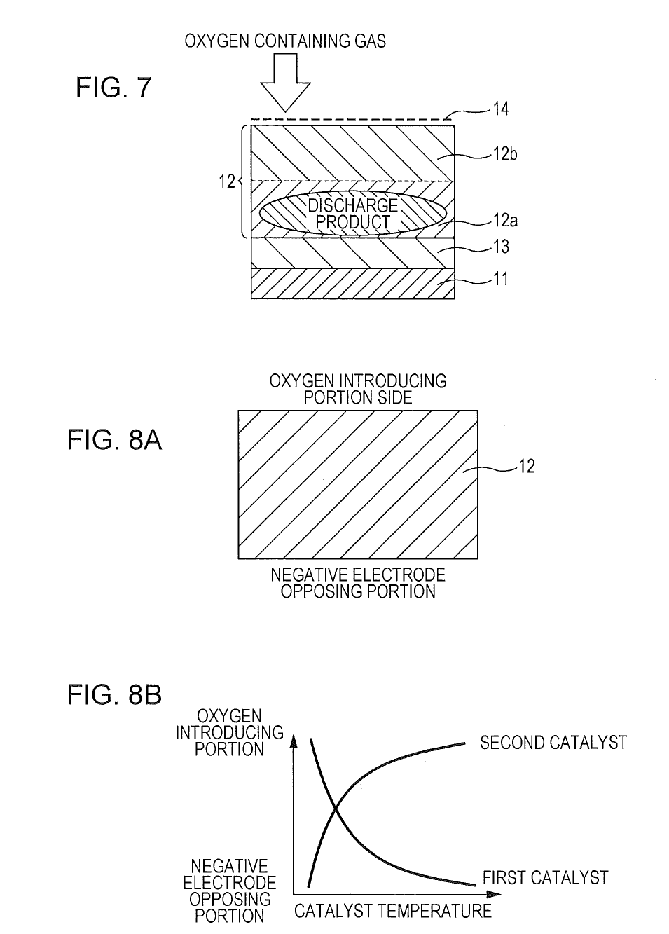

During discharging of this air battery, as shown in FIG. 7, since the first discharge over-voltage of the first catalyst that is present in the lower portion 12a of the air electrode 12 on the negative electrode 11 side is lower than the second discharge over-voltage of the second catalyst that is present in the upper portion 12b of the air electrode 12 on a side that is opposite to the negative electrode 11, the metal ions supplied from the negative electrode 11 react with oxygen, which permeates through the current collector 14 and is supplied to the air electrode 12, from the lower portion 12a of the positive electrode 12, whereby a discharge product is generated, and the discharge product is generated toward the current collector 14. For example, in a case where the negative electrode 11 is formed from lithium, Li₂O₂, Li₂O, and other Li products may be generated as the discharge product.

In addition, during charging of the air battery, in a case where a charge over-voltage of the first catalyst is approximately similar to or higher than a charge over-voltage of the second catalyst, as shown in FIG. 7, the discharge product, which is generated inside the air electrode 12, is decomposed from the upper portion 12b of the air electrode 12 on the current collector 14 side. Therefore, the oxygen, which is generated due to the decomposition, may be smoothly emitted to the outside from the upper surface of the air electrode 12 after passing through the inside of the air electrode 12, and thus retention of the air inside the air electrode 12 during the charging may be effectively suppressed.

In the certain embodiments disclosed herein, the air battery may be adapted for various uses. For example, the air battery can be adapted for use with a battery pack. In exemplary battery packs, the control unit may perform control of charging, discharging, over-discharging, or over-charging with respect to the air battery. Also, the air battery may be adapted for use with an electronic device where electric power is supplied from the air battery.

The electronic device may be any electronic device and may be a portable type device, a stationary type device, or any combination of both. Examples of the electronic device include cellular phones, mobile devices, robots, computers including personal computers, vehicular devices including in-vehicle devices, appliances including various household electric appliances, and others.

In addition, the air battery may be adapted for use with an electrically driven vehicle. The vehicle can include a converter to which electric power is supplied from an air battery and which converts the electric power to a driving force of the vehicle; and a control device that processes information regarding vehicle control on the basis of information related to the air battery.

In certain embodiments, in an electrically driven vehicle, the convertor may be supplied with electric power from the air battery and can rotate a motor to generate a driving force. The motor may use regenerative energy. In addition, the control device may perform, for example, information processing related to a vehicle control on the basis of remaining battery power of the air battery. This electrically driven vehicle can include, a hybrid car, an electric vehicle, an electric bike, an electric bicycle, and a railway vehicle, among others.

Further, the air battery may be adapted for use with an electric power system that may be constructed to be supplied with electric power from the air battery and/or to supply the electric power to the air battery from an electric power source. Electric power systems may include, for example, a smart grid, a household energy management system (HEMS), and a vehicle, among others, and may store electricity.

Still further, the air battery may be adapted for use with an electric-power-storage power supply. The electric-power-storage power supply may be constructed in such a manner that it is connected to an electronic device to which electric power is supplied. Yet further, the electric-power-storage power supply may be used in any electric power system or any electric power device regardless of its use, and for example, may also be used in a smart grid.

### Example 1

The button-type air battery was manufactured as described below.

The air electrode was manufactured as described below. Carbon black, Ru (a first catalyst), and PVDF were weighed in a weight ratio of 73:14:13, and these were added to N-methyl pyrrolidone solvent, and were mixed and agitated. The solvent was evaporated to prepare a power composition. In a similar manner, carbon black, Au (a second catalyst), and PVDF were weighed in a weight ratio of 73:14:13, and these were added to N-methyl pyrrolidone solvent, and were mixed and agitated. The solvent was evaporated to prepare a powder composition. The Au-containing powder composition, which was prepared as described above, was compressed to a Ni mesh (Ni-metal wire mesh, manufactured by Nilaco Corporation) that was processed in such a manner that lead portions could be led out from the air electrode in directions different from each other, and the Ru-containing powder composition was compressed on the Au-containing powder composition to manufacture the air electrode. The air electrode, which was manufactured in this manner, has a thickness of approximately 200 μm, and the air electrode was processed into a disc shape of 14 mmφ.

The negative electrode was manufactured as described below. For example, a Li metal (15 mmφ) was compressed on a Ni mesh that was processed into a disc shape to mold the negative electrode.

As the electrolytic solution, an electrolytic solution obtained by dissolving LiN(CF₃SO₂)₂ in 1-2-dimethoxyethane in a concentration of 1 mol/L was used. In addition, as the separator, a glass fiber separator was used.

The Li metal negative electrode that was compressed on the Ni mesh, the glass fiber separator that was impregnated with the electrolytic solution, the air electrode that was compressed on the Ni mesh, which were formed as described above, were laminated, and the resultant laminated body was accommodated in an exterior casing provided with an oxygen introducing opening. An exterior cup was caulked and hermetically sealed to the peripheral portion of the exterior casing through a gasket, whereby the button-type air battery was manufactured.

Charging and discharging of the air battery, which was manufactured in this manner, were performed under a pure oxygen (pressure: 1 atm) atmosphere, and it was confirmed that, during the discharging, the discharge product was generated in the air electrode from a side that was opposite to the Li metal negative electrode. Due to this, clogging of a portion of the air electrode on a current collector side to which oxygen was introduced was suppressed at an initial discharging stage, and thus the entirety of the air electrode was used as a reaction field. As a result, a high discharge capacity was realized. In addition, during charging, the discharge product was decomposed from a portion of the air electrode on the current collector side to which oxygen was introduced and oxygen was generated, and thus the oxygen was stably emitted to the outside of the battery.

As described above, according to the first embodiment, the following advantages may be obtained. For example, in the first embodiment, the first catalyst having the first discharge over-voltage is present in the lower portion 12a of the air electrode 12 on the negative electrode 11 side, and the second catalyst having the second discharge over-voltage higher than the first discharge over-voltage is present in the upper portion 12b of the air electrode 12. Accordingly, during discharging, the discharge product may be generated from the lower portion 12a of the air electrode 12. Due to this, it is possible to effectively prevent a surface of the air electrode 12 from being covered with the discharge product, and prevent a void, which is a passage of oxygen in the air electrode 12, from being clogged by the discharge product. As a result, diffusion of oxygen to the inside of the air electrode 12 may be maintained for a long time, and discharging may last to the final discharging stage. In addition, during charging, in a case where the charge over-voltage of the first catalyst is approximately similar to or higher than the charge over-voltage of the second catalyst, the discharge product may be decomposed from the upper portion 12b of the air electrode 12 on a side that is opposite to the negative electrode 11. Therefore, oxygen, which is generated by the decomposition of the discharge product, may be smoothly emitted to the outside from a surface of the air electrode 12 on the current collector 14 side after passing through the inside of the air electrode 12, and thus the oxygen may be effectively prevented from being retained inside the air electrode 12. As described above, during discharging, the diffusion of oxygen to the inside of the air electrode 12 may be maintained for a long time and thus a high discharge capacity may be obtained. As a result, it is possible to obtain an air battery with high performance in which a large current may be taken out. In addition, in a case where the charge over-voltage of the first catalyst is approximately similar to or higher than the charge over-voltage of the second catalyst, during charging, it is possible to prevent oxygen being retained inside the air electrode 12. Furthermore, since the first catalyst and the second catalyst, which have the discharge over-voltages different from each other, are present in the air electrode 12, and two plateaus are formed in a discharge curve of the air battery, detection of remaining power in accordance with the discharge voltage may become easy.

### 2. Second Embodiment

Air Battery

FIG. 8A shows a cross-sectional diagram illustrating an air electrode 12 of an air battery according to a second embodiment, and FIG. 8B shows a schematic diagram illustrating a catalyst concentration distribution in the air electrode 12. As shown in FIGS. 8A and 8B, in the air battery, the air electrode 12 contains a first catalyst having a first discharge over-voltage and a second catalyst having a second discharge over-voltage higher than the first discharge over-voltage in concentration distributions different from each other in a direction from a negative electrode 11 to the air electrode 12. For example, the concentration of the first catalyst continuously decreases from the negative electrode 11 to the air electrode 12, and the concentration of the second catalyst continuously increases from the negative electrode 11 to the air electrode 12. As a result, in a lower portion of the air electrode 12 on a negative electrode 11 side, the first catalyst is present with a higher concentration compared to the second catalyst, and in an upper portion of the air electrode 12 on a side that is opposite to the negative electrode 11, the second catalyst is present with a higher concentration compared to the first catalyst.

Configurations of this air battery other than the above-described configurations are similar to the air battery according to the first embodiment.

Method of Manufacturing Air Battery

The method of manufacturing this air battery is similar to the air battery according to the first embodiment except for a method of forming the air electrode 12. The air electrode 12 is formed as described below. For example, a second electrode material containing an organic solvent is first applied on a current collector 14 constructed by, for example, a metallic mesh, and the applied second electrode material is dried to evaporate the organic solvent. Before the second electrode material is dried, a first electrode material containing an organic solvent is applied on the second electrode material, and the first electrode material is dried to evaporate the organic solvent. The first electrode material and the second electrode material, which are formed as described above, are press-molded. As a result, the air electrode 12, in which in the lower portion of the air electrode 12 on the negative electrode 11 side, the first catalyst is present with a higher concentration compared to the second catalyst, and in the upper portion of the air electrode 12 on a side that is opposite to the negative electrode 11, the second catalyst is present with a higher concentration compared to the first catalyst, is formed.

Method of Using an Air Battery

The method of using this air battery is similar to the air battery according to the first embodiment.

According to the second embodiment, similar advantages as the first embodiment may be obtained.

### 3. Third Embodiment

Air Battery

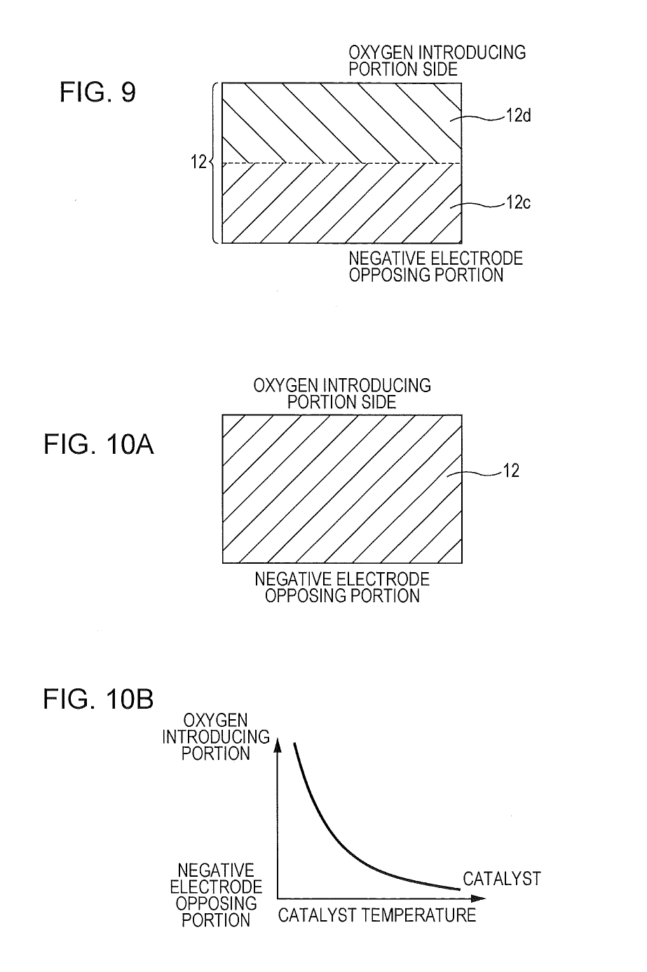

FIG. 9 shows an air battery according to a third embodiment. As shown in FIG. 9, in the air battery, a catalyst is present in a lower portion 12c of an air electrode 12 on a negative electrode 11 side, and the catalyst is not present in an upper portion 12d of the air electrode 12 on a side that is opposite to the negative electrode 11. In this case, the discharge over-voltage of the catalyst that is present in the lower portion 12c of the air electrode 12 is lower than the discharge over-voltage of an electrode material that constructs the upper portion 12d of the air electrode 12, for example, a conductive material such as carbon.

Configurations of the air battery other than the above-described configurations are similar to the air battery according to the first embodiment.

Method of Manufacturing an Air Battery

The method of manufacturing this air battery is similar to the air battery according to the first embodiment except for a method of forming the air electrode 12. The air electrode 12 is formed as described below. For example, a first electrode material containing a catalyst and a second electrode material not containing the catalyst are mixed into a predetermined organic solvent in a predetermined ratio, respectively, and the organic solvent is sufficiently evaporated from the first electrode material and the second electrode material, respectively. The first electrode material is placed on the second electrode material when the second electrode material is press-molded on a current collector 14 constructed by, for example, a metallic mesh, the press-molding is again performed. Thus, in certain embodiments, the air electrode 12, in which the catalyst is present in the lower portion 12c and the catalyst is not present in the upper portion 12d, is formed.

Method of Using an Air Battery

The method of using this air battery is similar to the air battery according to the first embodiment.

According to the third embodiment, similar advantages as the first embodiment may be obtained.

### 4. Fourth Embodiment

Air Battery

FIG. 10A shows a cross-sectional diagram illustrating an air electrode 12 of an air battery according to a fourth embodiment, and FIG. 10B shows a schematic diagram illustrating a catalyst concentration distribution in the air electrode 12. As shown in FIGS. 10A and 10B, in the air battery, the air electrode 12 contains one kind of catalyst, and a concentration of this catalyst continuously decreases from a negative electrode 11 to the air electrode 12. In this case, the discharge over-voltage of the catalyst that is present in the air electrode 12 is lower than the discharge over-voltage of an electrode material that constructs the air electrode 12, for example, a conductive material such as carbon.

Configurations of the air battery other than the above-described configurations are similar to the air battery according to the first embodiment.

Method of Manufacturing an Air Battery

The method of manufacturing this air battery is similar to the air battery according to the first embodiment except for a method of forming the air electrode 12. The air electrode 12 is formed as described below. For example, a catalyst-containing electrode material containing an organic solvent is first applied on a current collector 14 constructed by, for example, a metallic mesh, and the applied electrode material is dried to gradually evaporate the organic solvent. The electrode material, which is formed in this manner, is press-molded. Accordingly, the air electrode 12, in which a concentration of the catalyst continuously decreases from the negative electrode 11 to the air electrode 12, is formed.

Method of Using an Air Battery

The method of using this air battery is similar to the air battery according to the first embodiment.

According to the fourth embodiment, similar advantages as the first embodiment may be obtained.

### 5. Fifth Embodiment

Air Battery

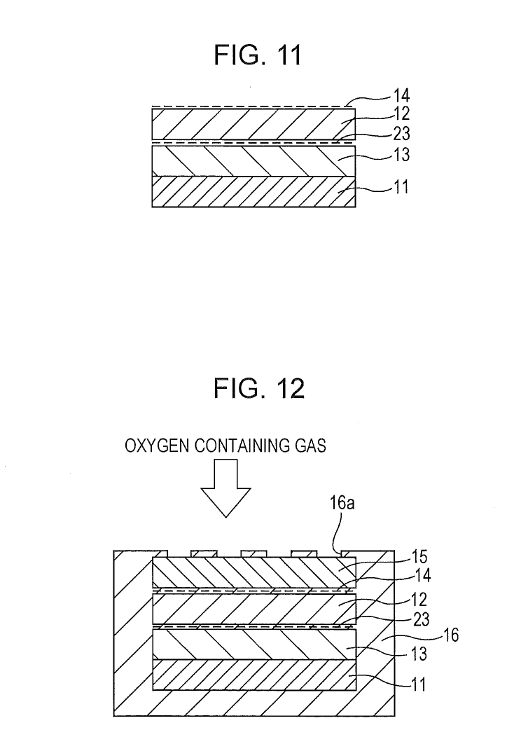

FIG. 11 shows an air battery according to a fifth embodiment. As shown in FIG. 11, this air battery includes a current collector 23 that is provided on a surface of an air electrode 12 on a negative electrode 11 side to be electrically connected to an air electrode 12. Similarly to the current collector 14, the current collector 23 allows electrons to enter the air electrode 12 and exit therefrom during charging and discharging of the air battery. The current collector 23 is constructed to permit entrance and exit of metal ions through the current collector 23. Similarly to the current collector 14, this current collector 23 is constructed by a metallic mesh. Although a material is not limited, a material formed from Ni (nickel) or stainless steel (SUS) may be used as the metallic mesh. Hole diameters and other properties of the metallic mesh are not limited. In certain embodiments, the current collectors 14 and 23 are constructed in an electrically independent manner.

Configurations of the air battery other than the above-described configurations are similar to the air battery according to the first embodiment.

Structural Example of Air Battery

FIG. 12 shows a structural example of this air battery. As shown in FIG. 12, in the air battery, an oxygen-permeable membrane 15 is provided on the current collector 14 formed on the air electrode 12. In addition, all of the negative electrode 11, an electrolyte layer 13, the current collector 23, the air electrode 12, the current collector 14, and the oxygen-permeable membrane 15 are accommodated inside a housing 16. Openings 16a are formed in an upper portion of the housing 16, which comes into contact with the oxygen-permeable membrane 15, and the air reaches the oxygen-permeable membrane 15 from the outside through the openings 16a. In addition, after reaching the oxygen-permeable membrane 15, the air permeates through the oxygen-permeable membrane 15, and is supplied to the air electrode 12.

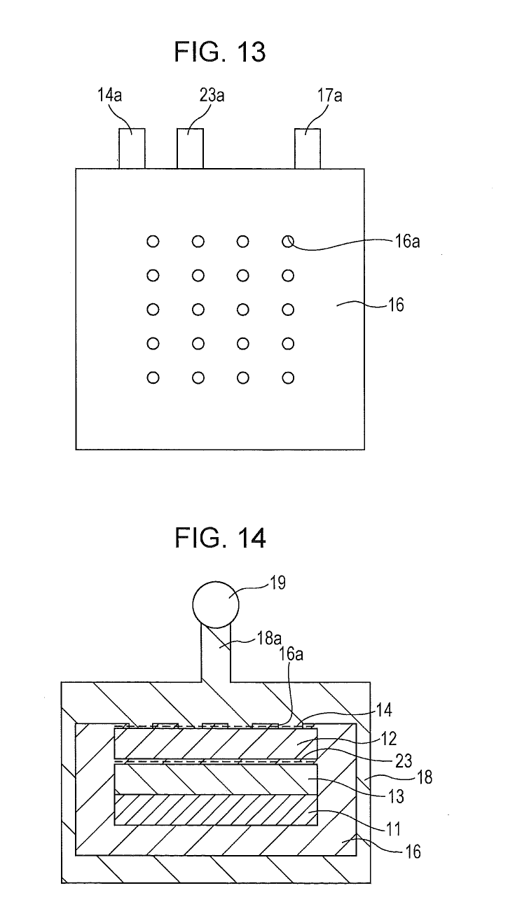

FIG. 13 shows an example of a view of the air battery shown in FIG. 12. As shown in FIG. 13, in this example, the air battery has a rectangular or square planar shape, and overall, the air battery has a quadrangular prism shape. The openings 16a are formed in an upper portion of the housing 16, which comes into contact with the oxygen-permeable membrane 15, in a two-dimensional matrix form. A lead portion 14a leads out from the current collector 14 to the outside of the battery. Furthermore, similarly, a lead portion 23a also leads out from the current collector 23 to the outside of the battery. Furthermore, although not shown in FIG. 12, a lead portion 17a also leads out to the outside of the battery from a current collector that is provided on a lower surface of the negative electrode 11 to be electrically connected to this negative electrode 11. In this example, the lead portions 14a, 17a, 23a lead out from only one side surface of the air battery, but there is no limitation thereto.

FIG. 14 shows another structural example of the air battery. As shown in FIG. 14, in this air battery, the oxygen-permeable membrane 15 is not provided differently from the air battery shown in FIG. 12. In addition, all of the negative electrode 11, the electrolyte layer 13, the current collector 23, the air electrode 12, and the current collector 14 are accommodated inside the housing 16. This housing 16 is accommodated inside a relatively large housing 18. This housing 18 has airtightness except for one end 18a, and the one end 18a is connected to a gas acquisition port of an oxygen bomb 19. In addition, oxygen may be supplied to the inside of the housing 18 in accordance with opening and closing of the oxygen bomb 19. The openings 16a are formed in an upper portion of the housing 16, which comes into contact with the air electrode 12, and oxygen, which is supplied to the inside of the housing 18, is supplied to the air electrode 12 through the openings 16a.

Method of Manufacturing an Air Battery

A method of manufacturing the air battery will be described.

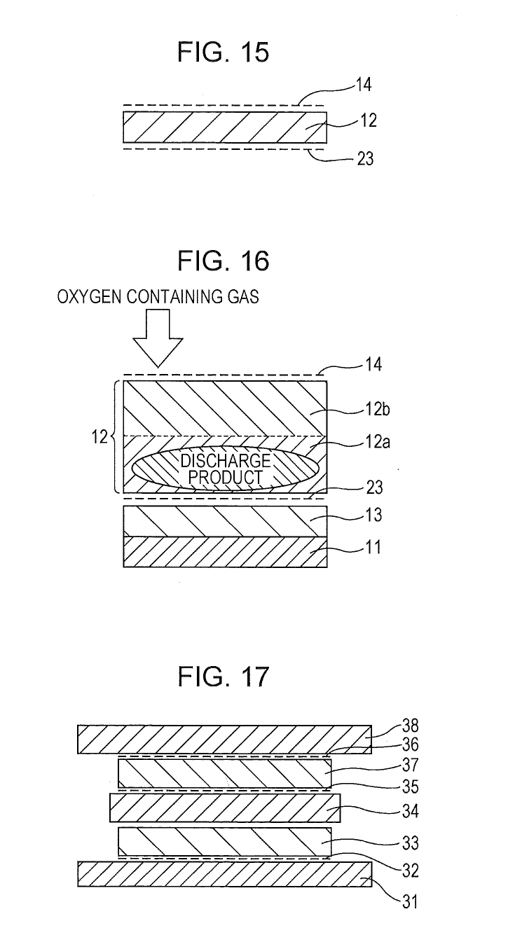

The negative electrode 11 is formed and, as shown in FIG. 15, the current collector 23 and the current collector 14 are formed on both surfaces (an upper surface and a lower surface) of the air electrode 12, respectively. The air electrode 12 including the current collector 23 and the current collector 14 may be manufactured, for example, as described below. For example, a first electrode material containing a first catalyst and a second electrode material containing a second catalyst are mixed into a predetermined organic solvent in a predetermined ratio, respectively, and the organic solvent is sufficiently evaporated from the first electrode material and the second electrode material, respectively. The second electrode material is press-molded on the current collector 14 constructed by, for example, a metallic mesh, and the first electrode material is placed on the second electrode material, and the press-molding is again performed. The first electrode material side is compressed to the current collector 23 constructed by a metallic mesh. In this manner, the air electrode 12, in which the first catalyst having a first discharge over-voltage is present in the lower portion 12a and the second catalyst having a second discharge over-voltage higher than the first discharge over-voltage is present in the upper portion 12b, the current collector 23 is connected to the lower portion 12a, and the current collector 14 is connected to the upper portion 12b, is formed.

A target air battery as shown in FIG. 11 is manufactured by performing processes similar to the first embodiment.

Method of Using an Air Battery

In the air battery, during discharging, a voltage, which is positive with respect to the negative electrode 11, is applied to the current collector 23 that is connected to a surface of the air electrode 12 on a negative electrode 11 side, or both the current collector 23 and the current collector 14. At this time, metal ions migrate from the negative electrode 11 to the air electrode 12 through the electrolyte layer 13, whereby electric energy is generated. On the other hand, during charging, a voltage, which is positive with respect to the negative electrode 11, is applied to the current collector 14 that is connected to a surface of the air electrode 12 on a side that is opposite to the negative electrode 11, or both the current collector 14 and the current collector 23. At this time, the metal ions migrate from the air electrode 12 to the negative electrode 11 through the electrolyte layer 13, whereby the electric energy is converted into chemical energy and is stored.

During discharging of this air battery, as shown in FIG. 16, when a voltage, which is positive with respect to the negative electrode 11, is applied to the current collector 23, metal ions supplied from the negative electrode 11 react with oxygen, which permeates through the current collector 14 and is supplied to the air electrode 12, from a portion of the positive electrode on the negative electrode 11 side of the air electrode 12, whereby a discharge product is generated, and a discharge product is generated toward the current collector 14. For example, in a case where the negative electrode 11 is formed from lithium, Li₂O₂, Li₂O, and other Li products may be generated as the discharge product.

In addition, during charging of the air battery, in a case where the charge over-voltage of the first catalyst is approximately similar to or higher than the charge over-voltage of the second catalyst, as shown in FIG. 16, when a voltage, which is positive with respect to the negative electrode 11, is applied to the current collector 14, the discharge product, which is generated inside the air electrode 12, is decomposed from a portion of the air electrode 12 on a current collector 14 side. Therefore, oxygen, which is generated by the decomposition, may be smoothly emitted to the outside from an upper surface of the air electrode 12 after passing through the inside of the air electrode 12, and thus retention of the air inside the air electrode 12 during the charging may be effectively suppressed.

### Example 2

The air battery was manufactured as described below.

The air electrode was manufactured as described below. Carbon black, Ru (a first catalyst), and PVDF were weighed in a weight ratio of 73:14:13, and these were added to N-methyl pyrrolidone solvent, and were mixed and agitated.

The solvent was evaporated to prepare a powder composition. In a similar manner, carbon black, Au (a second catalyst), and PVDF were weighed in a weight ratio of 73:14:13, and these were added to N-methyl pyrrolidone solvent, and were mixed and agitated. The solvent was evaporated to prepare a powder composition. The Au-containing powder composition, which was prepared as described above, was compressed to a Ni mesh (Ni-metal wire mesh, manufactured by Nilaco Corporation) that was processed in such a manner that a lead portion could be led out from the air electrode, the Ru-containing powder composition was compressed on the Au-containing powder composition, and the Ni mesh (Ni-metal wire mesh, manufactured by Nilaco Corporation) was further compressed on the Ru-containing powder composition to manufacture the air electrode. The air electrode, which was manufactured in this manner, has a thickness of approximately 200 μm, and the air electrode (excluding the lead portion) was processed to have a shape of approximately 3 cm×3 cm.

The negative electrode was manufactured as described below. For example, a Li metal (3 cm×3 cm) was compressed on a Ni mesh, which was processed into a shape in which a lead portion could be led out from a negative electrode portion, to mold the negative electrode.

As the electrolytic solution, an electrolytic solution obtained by dissolving LiN(CF₃SO₂)₂ in 1-2-dimethoxyethane in a concentration of 1 mol/L was used. In addition, as the separator, a glass fiber separator was used. In addition, as the housing, an aluminum laminated film was used.

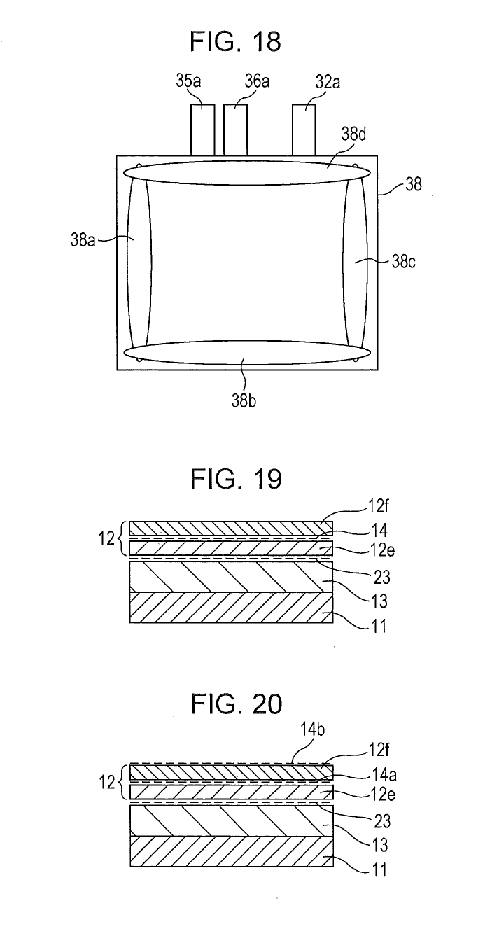

As shown in FIG. 17, a Li metal negative electrode 33 was disposed on an aluminum laminated film 31 to which a Ni mesh 32 is connected on a lower surface side thereof. An electrolytic solution was added dropwise on the Li metal negative electrode 33, and a glass fiber separator 34, which was processed to cover the entirety of the Li metal negative electrode 33, was disposed on the Li metal negative electrode 33. The electrolytic solution was added dropwise from an upper side of the glass fiber separator 34, and an air electrode 37, to which Ni meshes 35 and 36 are connected on an upper surface and a lower surface, respectively, was disposed on the glass fiber separator 34. Furthermore, the air electrode 37 was covered with an aluminum laminated film 38, and lead portions of the Ni meshes 32, 35, and 36 were led out to the outside of the aluminum laminated films 31 and 38. A view of this state is shown in FIG. 18. As shown in FIG. 18, in this state, heat pressing was performed along three sides of the aluminum laminated films 31 and 38 excepting a side from which the lead portions of the Ni meshes 32, 35, and 36 were led out to weld the laminated films 31 and 38, and heat pressing was performed with respect to the remaining one side under vacuum, whereby the air battery was manufactured. FIG. 18 shows a view of the air battery. In FIG. 18, positions at which the heat pressing was performed were indicated by reference numerals 38a to 38d. The aluminum laminated film 38 of the air battery, which was manufactured in this manner, on an air electrode 37 side was processed using a cutter knife or other suitable tools to form an oxygen introducing opening.

Charging and discharging of the air battery, which was manufactured in this manner, were performed under a pure oxygen (pressure: 1 atm) atmosphere, it was confirmed that when the discharging was performed using the Ni mesh 35 (corresponding to the current collector 23) that was opposite to the Li metal negative electrode 33, during the discharging, the discharge product was generated in the air electrode 37 from a side that was opposite to the Li metal negative electrode 33. Due to this, clogging of a portion of the air electrode 37 on an aluminum laminated film 38 side to which oxygen was introduced was suppressed at an initial discharging stage, and thus the entirety of the air electrode 37 was used as a reaction field. As a result, a high discharge capacity was realized. In addition, conversely, when the charging was performed using the Ni mesh 36 (corresponding to the current collector 14) on the aluminum laminated film 38 side, during the charging, the discharge product was decomposed from a portion of the air electrode 37 on a side to which oxygen was introduced and oxygen was generated, and thus the oxygen was stably emitted to the outside of the battery.

According to the fifth embodiment, in addition to similar advantages as the first embodiment, the following advantages may be obtained. For example, in addition to similar configurations as the first embodiment, the air battery of the fifth embodiment includes the current collector 23 that is provided on the surface of the air electrode 12 on the negative electrode 11 side to be electrically connected to the air electrode 12. Therefore, during discharging, in addition to the effect of allowing the discharge product to be generated from the lower portion 12a of the air electrode 12 on the negative electrode 11 side by distributing the first catalyst and the second catalyst in the air electrode 12 as described above, it is possible to obtain an effect of allowing the discharge product to be generated in the air electrode 12 from a portion on the negative electrode 11 side by applying a voltage, which is positive with respect to the negative electrode 11, to the current collector 23. As a result, it is possible to allow the discharge product to be generated from the lower portion 12a of the air electrode 12 on the negative electrode 11 side in a relatively reliable manner, and thus the discharge capacity of the air battery may be further increased.

### 6. Sixth Embodiment

Air Battery

FIG. 19 shows an air battery according to a sixth embodiment. As shown in FIG. 19, in the air battery, an air electrode 12 has a two-layer structure of a lower air electrode 12e and an upper air electrode 12f. In this case, a current collector 14 is provided between the lower air electrode 12e and the upper air electrode 12f to be electrically connected to the lower air electrode 12e and the upper air electrode 12f. In other words, in this case, the current collector 14 is provided in the air electrode 12 including the lower air electrode 12e and the upper air electrode 12f. Configurations of the air battery other than the above-described configuration are similar as the air battery according to the fifth embodiment.

Method of Manufacturing Air Battery

The method of manufacturing the air battery is similar to the air battery according to the fifth embodiment except that the air electrode 12 is constructed by a two-layer structure of the lower air electrode 12e and the upper air electrode 12f, and the current collector 14 is provided between the lower air electrode 12e and the upper air electrode 12f.

Method of Using an Air Battery

The method of using this air battery is similar to the air battery according to the fifth embodiment.

According to the sixth embodiment, similar advantages as the fifth embodiment may be obtained.

### 7. Seventh Embodiment

Air Battery

FIG. 20 shows an air battery according to a seventh embodiment. As shown in FIG. 20, in the air battery, an air electrode 12 has a two-layer structure of a lower air electrode 12e and an upper air electrode 12f. In this case, a current collector 14a is provided between the lower air electrode 12e and the upper air electrode 12f to be electrically connected to the lower air electrode 12e and the upper air electrode 12f. In addition to this, a current collect 14b is provided on the upper air electrode 12f to be electrically connected to the upper air electrode 12f. Configurations of this air battery other than the above-described configurations are similar to the air battery according to the fifth embodiment.

Method of Manufacturing an Air Battery

The method of manufacturing the air battery is similar to the air battery according to the fifth embodiment except that the air electrode 12 is constructed by a two-layer structure of the lower air electrode 12e and the upper air electrode 12f, the current collector 14a is provided between the lower air electrode 12e and the upper air electrode 12f, and the current collector 14b is provided on the upper air electrode 12f.

Method of Using an Air Battery

The method of using this air battery is similar to the air battery according to the fifth embodiment.

According to the seventh embodiment, similar advantages as the fifth embodiment may be obtained.

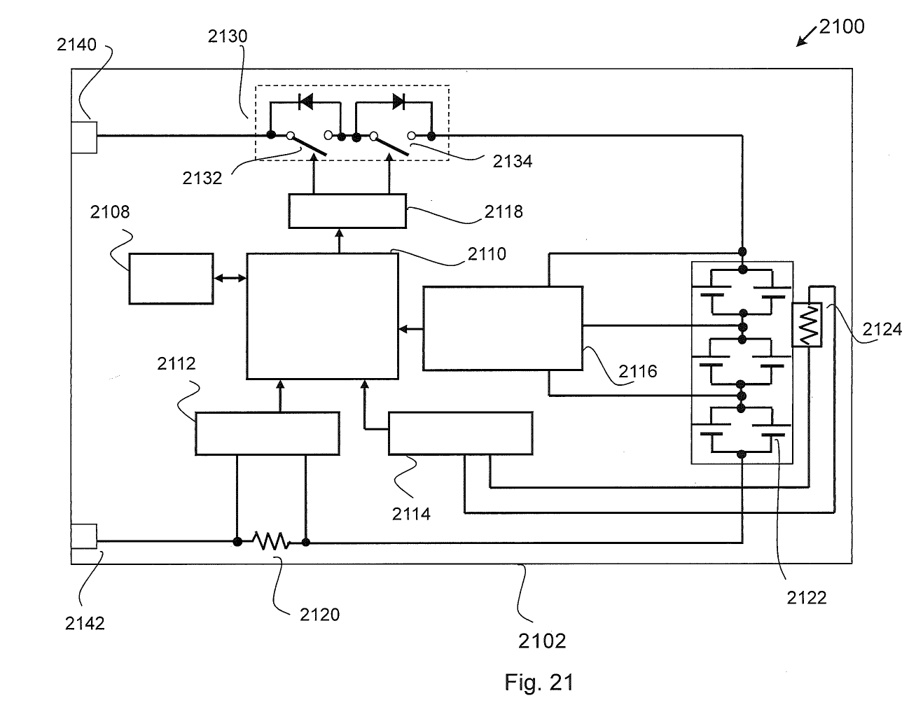

FIG. 21 is a diagram illustrating a battery pack according to certain embodiments. In FIG. 21, the battery pack 2100 includes a memory 2108 connected to a controller 2110. The controller 2110 is also connected to a current measurement part 2112, a temperature detector part 2114, a voltage detector part 2116, and a switch control part 2118. The current measurement part 2112 is connected to a resistor 2120, which is connected to cells 2122. The cells 2122 are connected to a resistor 2124, which is connected to the temperature detector part 2114. The cells 2122 are also connected to a switch 2130 that includes a charge control switch 2132 and a discharge control switch 2134.

The above referenced components may be encompassed by external packaging 2102. The battery pack 2100 also includes a positive electrode terminal 2140 and a negative electrode terminal 2142, connected as shown. In embodiments, the cells 2122 are an air battery in accordance with the present disclosure.

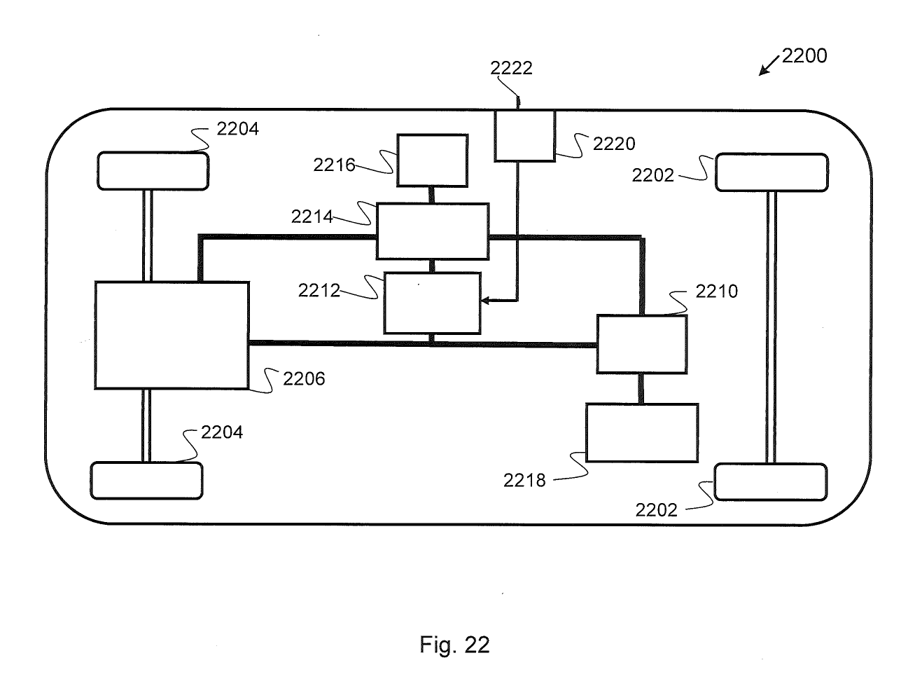

FIG. 22 is a diagram illustrating a vehicle according to certain embodiments. In particular, FIG. 22 illustrates a hybrid vehicle 2200 that includes wheels 2202 and drive wheels 2204. An electric power drive force conversion device 2206 is connected to the drive wheels 2204, and to an electricity generator 2210, a battery 2212, and a vehicle control apparatus 2214, as shown. The vehicle control apparatus 2214 is connected to sensors 2216.

The electricity generator 2210 is connected to an engine 2218, and the battery 2212 may be connected to a charge port 2220, which may interface with an external power supply 2222. Various other components, including structural and mechanical components, are not shown in FIG. 22. In embodiments, the battery 2212 is an air battery in accordance with the present disclosure.

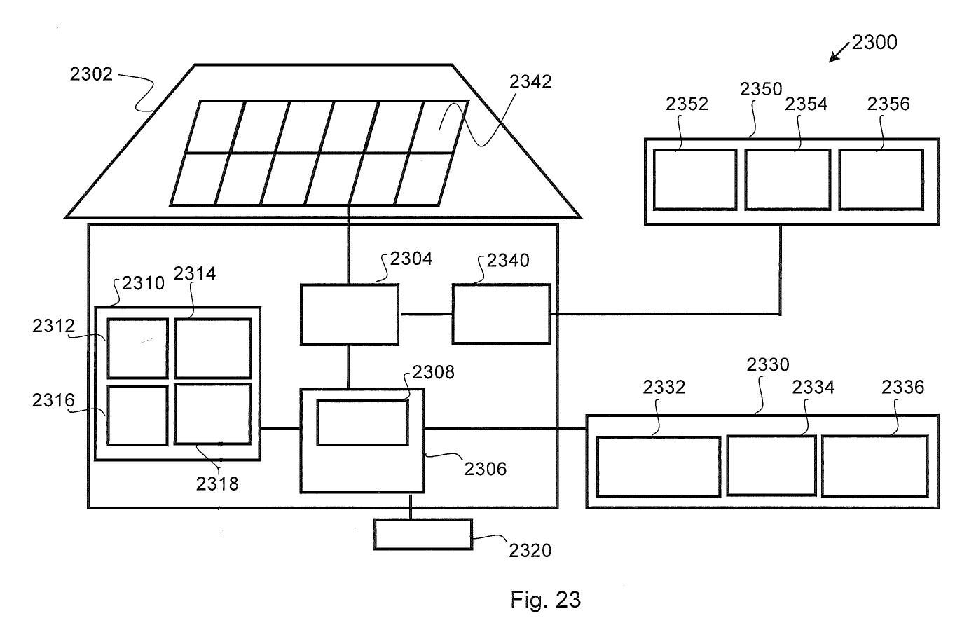

FIG. 23 is a diagram illustrating a power system according to certain embodiments. In FIG. 23, the power system 2300 includes a house 2302 that has a power hub 2304. The power hub is connected to an electric storage device 2306 interfacing with a control apparatus 2308, which may include sensors, or be connected to sensors. The electric storage device 2306 may be connected to power consumption electronics 2310, including a bath 2312, a refrigerator 2314, a television 2316, and an air conditioner 2318. In addition, the electric storage device 2306 may be connected to a server 2320, which may reside outside of the house 2302. The electric storage device 2306 may also be connected to additional power consumption electronics 2330, including an electrically driven vehicle 2332, a hybrid vehicle 2334, and a motorbike 2336.

The power hub 2304 may be connected to power-generating equipment 2342 and a smart meter 2340, which is connected to a centralized power system 2350 that includes, for example, heat power 2352, nuclear power 2354, and hydraulic power 2356. In embodiments, the connections between the components in FIG. 23 may be a power network and/or an information network, and the electric storage device 2306 may be an air battery in accordance with the present disclosure.

Hereinbefore, the certain embodiments and examples have been described in detail, but the present disclosure is not limited to the above-described embodiment and examples, and various modifications may be made.

For example, the numerical values, the structures, the configurations, the shapes, the materials, and other referenced components in the above-described embodiments and examples are illustrative only, and different numerical values, structures, configurations, shapes, materials, and other components may be used. For example, the catalyst distribution in the air electrode 12 may be a catalyst distribution different from that of the first to fourth certain embodiments to the extent that during discharging, the discharge product is generated from a portion of the air electrode 12 on the negative electrode 11 side. In addition, for example, in the sixth and seventh certain embodiments, the air electrode 12 was divided into two pieces of the lower air electrode 12e and the upper air electrode 12f, but the air electrode 12 may be divided into three pieces or more. Furthermore, two or more of the above-described first to seventh embodiments may be combined.

The present disclosure, in various embodiments, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. The features of the embodiments of the disclosure may be combined in alternate embodiments other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the description of the disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

In addition, the present disclosure may have the flowing configuration.

(1) A battery device, comprising:
a negative electrode;
an air electrode; and
an electrolyte layer that is provided between the negative electrode and the air electrode,
wherein the air electrode comprises a plurality of portions having discharge over-voltages that are different between each portion in a direction from the negative electrode to the air electrode, and
wherein a discharge over-voltage of a portion of the air electrode closest to the negative electrode is lower than a discharge over-voltage of the other of the plurality of portions.
   (2) The device of (1), wherein the negative electrode comprises a metal.
   (3) The device of (1), wherein the discharge over-voltage of each portion in the plurality of portions increases in the direction from the negative electrode toward the air electrode.
   (4) The device of (3), wherein the increase is substantially continuous.
   (5) The device of (1), further comprising a catalyst located within at least one of the plurality of portions.
   (6) The device of (1), further comprising a plurality of catalysts positioned within the plurality of portions, wherein each of the plurality of catalysts has a discharge over-voltage that is different between each catalyst.
   (7) The device of (6), wherein the discharge over-voltage of each portion in the plurality of portions increases in a direction from the negative electrode to the air electrode.
   (8) The device of (1), wherein the plurality of portions is comprised of two portions, wherein a first catalyst having a first discharge over-voltage is present in the first portion and a second catalyst having a second discharge over-voltage higher than the first discharge over-voltage is present at the second portion, wherein the first portion is closer to the negative electrode than the second portion.
   (9) The device of (8), wherein a difference in discharge over-voltage between the first portion and the second portion is at least 0.01 V.
   (10) The device of (6), wherein a concentration distribution of the plurality of catalysts decreases in a direction from the negative electrode to the air electrode.
   (11) The device of (6), wherein a charge over-voltage of a first catalyst is approximately the same as or higher than a charge over-voltage of a second catalyst, and wherein the first catalyst is closer to the negative electrode than the second catalyst.
   (12) An air battery adapted for use with an electronic device, comprising:
an air battery, wherein the air battery comprises a negative electrode, an air electrode, and an electrolyte layer that is provided between the negative electrode and the air electrode;
wherein the air electrode comprises a plurality of portions having discharge over-voltages that are different between each portion in a direction from the negative electrode to the air electrode, and
wherein a discharge over-voltage of a portion of the air electrode closest to the negative electrode is lower than a discharge over-voltage of the other of the plurality of portions.
   (13) The air battery of (12), wherein the electronic device is a battery pack comprising a control unit that controls the air battery, and wherein the air battery is enclosed in a housing.
   (14) The air battery of (12), wherein the electronic device is a vehicle.
   (15) The air battery of (14), wherein the vehicle comprises a converter electrically connected to the air battery.
   (16) The air battery of (15), wherein the vehicle further comprises a control device that processes information related to the air battery.
   (17) The air battery of (12), wherein the electronic device is an electric power system that supplies power to the air battery from an electric power source.
   (18) The air battery of (12), wherein the electronic device is an electric power system, and wherein the air battery supplies power to the electric power system.
   (19) The air battery of (17), wherein the electric power system comprises at least one of a smart grid, a household energy management system, and a vehicle.
   (20) A method of manufacturing a battery device, comprising the steps of:
forming a negative electrode;
forming an air electrode; and
forming an electrolyte layer that is provided between the negative electrode and the air electrode,
wherein the air electrode comprises a plurality of portions having discharge over-voltages that are different between each portion in a direction from the negative electrode to the air electrode; and
assembling each of the negative electrode, the air electrode, and the electrolyte layer to form the battery device,
wherein a discharge over-voltage of a portion of the air electrode closest to the negative electrode is lower than a discharge over-voltage of the other of the plurality of portions.
   (21) An air battery including: a negative electrode containing at least a metal; an air electrode; and an electrolyte layer that is provided between the negative electrode and the air electrode, wherein a discharge over-voltage of a portion of the air electrode on a negative electrode side is lower than a discharge over-voltage of other portions.
   (22) The air battery according to (21), wherein the air electrode includes a plurality of portions in which discharge over-voltages are different from each other in a direction from the negative electrode to the air electrode.
   (23) The air battery according to (22), wherein catalysts, which have discharge over-voltages different from each other, are present in the plurality of portions of the air electrode, respectively.
   (24) The air battery according to any one of (21) to (23), wherein the air electrode includes a first portion on the negative electrode side and a second portion on a side that is opposite to the negative electrode, a first catalyst having a first discharge over-voltage is present at the first portion, and a second catalyst having a second discharge over-voltage higher than the first discharge over-voltage is present at the second portion.
   (25) The air battery according to (24), wherein the second discharge over-voltage is higher than the first discharge over-voltage by 0.01 V or more.
   (26) The air battery according to (21) or (22), wherein, in the air electrode, a first catalyst having a first discharge over-voltage is present in a concentration distribution in which a concentration decreases in a direction from the negative electrode to the air electrode, and a second catalyst having a second discharge over-voltage higher than the first discharge over-voltage is present in a concentration distribution in which a concentration increases in a direction from the negative electrode to the air electrode.
   (27) The air battery according to (21) or (22), wherein the air electrode includes a first portion on the negative electrode side and a second portion on a side that is opposite to the negative electrode, a catalyst is present at the first portion, the catalyst is not present at the second portion, and a discharge over-voltage of the second portion is higher than a discharge over-voltage of the catalyst.
   (28) The air battery according to (21) or (22), wherein, in the air electrode, a catalyst is present in a concentration distribution in which a concentration decreases in a direction from the negative electrode to the air electrode.
   (29) The air battery according to any one of (21) to (28), wherein a charge over-voltage of a portion of the air electrode on a negative electrode side is approximately the same as or higher than a charge over-voltage of other portions.

The present disclosure contains subject matter related to that disclosed in Japanese Priority Patent Application JP 2012-083480 filed in the Japan Patent Office on Apr. 2, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A battery device, comprising:
a negative electrode;
an air electrode; and
an electrolyte layer that is provided between the negative electrode and the air electrode,
wherein the air electrode comprises a plurality of portions having discharge over-voltages that are different between each portion in a direction from the negative electrode to the air electrode, and
wherein a discharge over-voltage of a portion of the air electrode closest to the negative electrode is lower than a discharge over-voltage of the other of the plurality of portions.

2. The device of claim 1, wherein the negative electrode comprises a metal.

3. The device of claim 1, wherein the discharge over-voltage of each portion in the plurality of portions increases in the direction from the negative electrode toward the air electrode.

4. The device of claim 3, wherein the increase is substantially continuous.

5. The device of claim 1, further comprising a catalyst located within at least one of the plurality of portions.

6. The device of claim 1, further comprising a plurality of catalysts positioned within the plurality of portions, wherein each of the plurality of catalysts has a discharge over-voltage that is different between each catalyst.

7. The device of claim 6, wherein the discharge over-voltage of each portion in the plurality of portions increases in a direction from the negative electrode to the air electrode.

8. The device of claim 1, wherein the plurality of portions is comprised of two portions, wherein a first catalyst having a first discharge over-voltage is present in the first portion and a second catalyst having a second discharge over-voltage higher than the first discharge over-voltage is present at the second portion, wherein the first portion is closer to the negative electrode than the second portion.

9. The device of claim 8, wherein a difference in discharge over-voltage between the first portion and the second portion is at least 0.01 V.

10. The device of claim 6, wherein a concentration distribution of the plurality of catalysts decreases in a direction from the negative electrode to the air electrode.

11. The device of claim 6, wherein a charge over-voltage of a first catalyst is approximately the same as or higher than a charge over-voltage of a second catalyst, and wherein the first catalyst is closer to the negative electrode than the second catalyst.

12. An air battery adapted for use with an electronic device, comprising:
an air battery, wherein the air battery comprises a negative electrode, an air electrode, and an electrolyte layer that is provided between the negative electrode and the air electrode;
wherein the air electrode comprises a plurality of portions having discharge over-voltages that are different between each portion in a direction from the negative electrode to the air electrode, and
wherein a discharge over-voltage of a portion of the air electrode closest to the negative electrode is lower than a discharge over-voltage of the other of the plurality of portions.

13. The air battery of claim 12, wherein the electronic device is a battery pack comprising a control unit that controls the air battery, and wherein the air battery is enclosed in a housing.

14. The air battery of claim 12, wherein the electronic device is a vehicle.

15. The air battery of claim 14, wherein the vehicle comprises a converter electrically connected to the air battery.

16. The air battery of claim 15, wherein the vehicle further comprises a control device that processes information related to the air battery.

17. The air battery of claim 12, wherein the electronic device is an electric power system that supplies power to the air battery from an electric power source.

18. The air battery of claim 12, wherein the electronic device is an electric power system, and wherein the air battery supplies power to the electric power system.

19. The air battery of claim 17, wherein the electric power system comprises at least one of a smart grid, a household energy management system, and a vehicle.

20. A method of manufacturing a battery device, comprising the steps of:
forming a negative electrode;
forming an air electrode; and
forming an electrolyte layer that is provided between the negative electrode and the air electrode,
wherein the air electrode comprises a plurality of portions having discharge over-voltages that are different between each portion in a direction from the negative electrode to the air electrode; and
assembling each of the negative electrode, the air electrode, and the electrolyte layer to form the battery device,
wherein a discharge over-voltage of a portion of the air electrode closest to the negative electrode is lower than a discharge over-voltage of the other of the plurality of portions.
